(19) United States
(12) Patent Application Publication
(10) Pub. No.: US 2006/0008788 A1
(43) Pub. Date: Jan. 12, 2006

(54) Method and system for work-embedded learning and group facilitation using a computer-delivery system

(75) Inventors: Lynn Dorsett, Scottsdale, AZ (US); Herbert Michael Christopher Brennan, Orford (GB); Claudette G. Drankoski, Endwell, NY (US); Phyllis Mae Finnemore, Driftwood, TX (US); Wesley Willis Gould, Halifax (CA); Gail M. Hock, Reno, NV (US); Tracy J. Hopper, Weybridge (GB); Adrian Michael Johnston, Lucasville (CA); Daniel P. Michel, Naperville, IL (US); Howard K. Smith, Atlanta, GA (US); Hope E. Turner, Northville, MI (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 10/887,314

(22) Filed: Jul. 9, 2004

(51) Int. Cl. G09B 3/00

(52) U.S. Cl. 434/350

(57) ABSTRACT

A method (and structure) of conducting a group intervention includes executing a group intervention module that includes a set of instructions to guide the group through a completion of a group task as the group task is being executed by the group.

### BACKGROUND OF THE INVENTION

1. Field of the Invention

The present invention generally relates to a method of conducting group interventions and/or providing work embedded learning. More specifically, computer modules, referred to as Impact Guides, teach group members how to accomplish a group task and guide them up through the completion of the task.

2. Description of the Related Art

Humans are social beings and human culture is permeated by groups. Regardless of its nature, a group is often expected to perform a specific group task. Often a group task is not well understood or articulated either to the group as a whole or to individuals forming the group.

Examples of group tasks abound in military, government, and business units, where group units routinely perform their expected tasks under highly structured settings, but group dynamics occur in other less structured environments such as social circles.

In group dynamics, the term “group intervention” refers to a generic process in which guidance is provided in real-time to a group so that its members can go about performing the expected group task as that task is being performed by the group. In many groups, particularly in business environments in which such group tasks are well structured, a specially-trained expert (e.g., a “facilitator”) provides the necessary group intervention skills.

Examples of group interventions in a corporate environment might be:

a group of managers assembled for the task of rating and ranking a group of employees for the purpose of providing additional employee compensation; or

a group of employees assembled to form a team to address a specific or generic problem and having an initial task of defining a mission statement.

However, contributing as a group member may often require skills that individual group members may not necessarily bring with them to the group, let alone the specific skills to perform the specific task allocated to the group. Particularly without the structured approach of a trained facilitator, conventional methods of group intervention tend to suffer from a number of problems, including, for example:

1. Left to their own devices, individuals generally do not collaborate in the most effective manner, whether in a face-to-face or in an online learning environment. Work groups asked to achieve a common goal also do not instinctively and effectively collaborate. Interactions need to be structured, based on best practices and some way to learn how to adapt them to a group's own use.

2. Groups need access to best practices and a way to learn how to use them that fits within their busy calendars. Finding time to schedule collaborative learning is nearly impossible for work groups. When learning must be scheduled, workers resist, or may not be trained in time to meet the needs of their work group. Groups that leave training to the individual end up with incomplete results, e.g., some trained and some untrained members.

3. Most performance support and training programs are designed for individual workers. And while an individual may be trained, a group will not be effective until all members are trained.

4. Many performance support tools do not build skills in the worker. Instead they bypass learning by providing a pre-prepared decision or work artifact.

5. Transferring newly learned knowledge to the job is an ongoing problem for training programs. If new knowledge is not used, then it is not retained.

6. In the name of cost-savings and urgency, employees are asked to be experts in many fields in addition to their specific subject matter expertise. Few employees have all of the required skills, nor do they have the time to build skills at the expense of doing their assigned tasks.

Currently, there is no method that effectively addresses all of the above problems. What does exist is automated meeting facilitation or assistance with a single group function tool.

For example, Open Text Corporation, with U.S. Head Office in Lincolnshire, Ill., offers a program entitle “Livelink for Collaboration” as a web-based environment for project teams to work together. The technique is understood as based on “Livelink virtualteams” that has seven team-building processes built-in “teamroom”. it has no audio prompting.

As a second example, FIG. 1 shows a partial screen 100 from Facilitate.com, offering real time interaction with a distributed meeting software. It is understood as being an e-meeting conducted in accordance with an agenda that describes a time window for each agenda item 101. Meeting members can join into the e-meeting by clicking on the prompt 102. However, this technique offers no learning for the group members relative to a group task.

Since these and other conventional methods do not efficiently address all of the above-mentioned six problems and others, a need continues to exist to provide more effective methods for group interventions.

Thus, exemplary problems being addressed by the present invention include the following.

In the past, high risk situations required an experienced facilitator for each customer situation involving a group task. The skills required for the group task execution were typically non-complex, yet essential to mitigate the risks involved. Usually, there were very limited number of skilled resources available to deploy to a very large audience and a very constrained budget. Often the size of the audience and urgency of need precluded preparatory classes for group members.

Moreover, consistency of execution is often important, particularly when executing group work with legal or policy implications or when using certain techniques will affect the outcome.

### SUMMARY OF THE INVENTION

In view of the foregoing, and other, exemplary problems, drawbacks, and disadvantages of the conventional system, it is an exemplary feature of the present invention to provide a framework into which can be placed any kind of group intervention, which framework is referred to in the present invention as an “Impact Guide”.

It is another exemplary feature of the present invention to provide a technique in which facilitators conventionally used for group interventions can be replaced by a computerized tool.

It is another exemplary feature of the present invention to provide a computer-assisted method of embedded learning.

It is another exemplary feature of the present invention to provide a method that incorporates effective learning principles into group interventions.

To achieve the above exemplary features and others, in a first exemplary aspect of the present invention, described herein is a method (and structure) of conducting a group intervention, including executing a group intervention module including a set of instructions to guide the group through a completion of a group task as the group task is being executed by the group.

In a second exemplary aspect of the present invention, described herein is a computerized method of work embedded learning, including executing a group intervention module that includes a set of instructions to guide a group through a completion of a group task as the group task is being executed by the group.

In a third exemplary aspect of the present invention, described herein is an e-leaming module including a set of instructions to guide a group through a completion of a group task as the group task is being executed by the group.

In a fourth exemplary aspect of the present invention, described herein is an apparatus including a memory storing an e-learning module including a set of instructions to guide a group through a completion of a group task as the group task is being executed by the group.

In a fifth exemplary aspect of the present invention, described herein is a system including a processor for executing an e-learning module that includes a set of instructions to guide a group through a completion of a group task as the group task is being executed by the group.

In a sixth exemplary aspect of the present invention, described herein is a computerized tool to prepare an e-leaming module, including a graphical user interface to allow entry of inputs from an input device and to provide a display on a display device, a memory containing at least one template for information to be presented in the e-learning module, and an editor to receive the inputs and place the inputs into a format for template, wherein at least one of the templates provides a set of instructions to guide a group through a completion of a group task as the group task is being executed by the group.

In a seventh exemplary aspect of the present invention, described herein is a signal-bearing medium tangibly embodying a program of machine-readable instructions executable by a digital processing apparatus to perform a method of conducting a group intervention, the method including presenting a set of instructions to guide a group through a completion of a group task as the group task is being executed by the group.

In an eighth exemplary aspect of the present invention, described herein is a signal-bearing medium tangibly embodying a program of machine-readable instructions executable by a digital processing apparatus to execute a computerized tool to prepare an e-leaming module, the tool including a graphical user interface to allow entry of inputs from an input device and to provide a display on a display device, a memory containing at least one template for information to be presented in the e-leaming module, and an editor to receive the inputs and place the inputs into a format for the template, wherein at least one of the templates provides a set of instructions to guide a group through a completion of a group task as the group task is being executed by the group.

With the above and other features, the present invention allows an untrained group of individuals to achieve a group task, including, if appropriate, providing training to the group members for that task as an integral feature of the group meeting that is set up to execute the completion of that task.

As will be better understood after taking the following discussion into account, the present invention, therefore, offers a number of benefits over conventional methods.

For example, it provides an embodiment of “just-in-time” learning. It also provides a work-embedded learning approach for groups that inherently maximizes value from the time spent. It is a process that can be driven by a single group member, leader, or manager. Its flexible design concept can support customized learning paths for all levels of experience and knowledge.

Moreover, the inventive method's e-facilitation can produce scaleable and repeatable learning and reduces duplication of effort. Its format as being available electronically via a network or diskette modules provides a low delivery cost. Additionally, since the facilitation comes in electronic form, it is available via download from the internet and does not impact the scheduling of the group meeting. In other words, the present invention is ready when its user is ready.

Thus, the present invention provides an improved method of conducting group interventions and work embedded learning.

### BRIEF DESCRIPTION OF THIE DRAWINGS

The foregoing and other exemplary features, aspects and advantages will be better understood from the following detailed description of an exemplary embodiment of the invention with reference to the drawings, in which:

FIG. 1 shows a partial screen display 100 of a conventional on-line group meeting;

FIG. 2 exemplarily shows a group meeting 200 using the Impact Guides concept of the present invention;

FIG. 3 exemplarily illustrates a method 3 00 for conducting a group meeting held in accordance with the present invention;

FIG. 4 exemplarily illustrates an Instruction Screen 400;

FIG. 5 illustrates the Instruction Screen in an exemplary schematic format 500;

FIG. 6 exemplarily illustrates an Interaction Screen 600;

FIG. 7 illustrates the Interaction Screen in an exemplary schematic format 700;

FIG. 8 illustrates an exemplary block diagram 800 of a computerized tool in accordance with the present invention;

FIG. 9 illustrates an exemplary hardware/information handling system 900 for incorporating the present invention therein; and

FIG. 10 illustrates a signal bearing medium 1000 (e.g., storage medium) for storing steps of a program of a method according to the present invention.

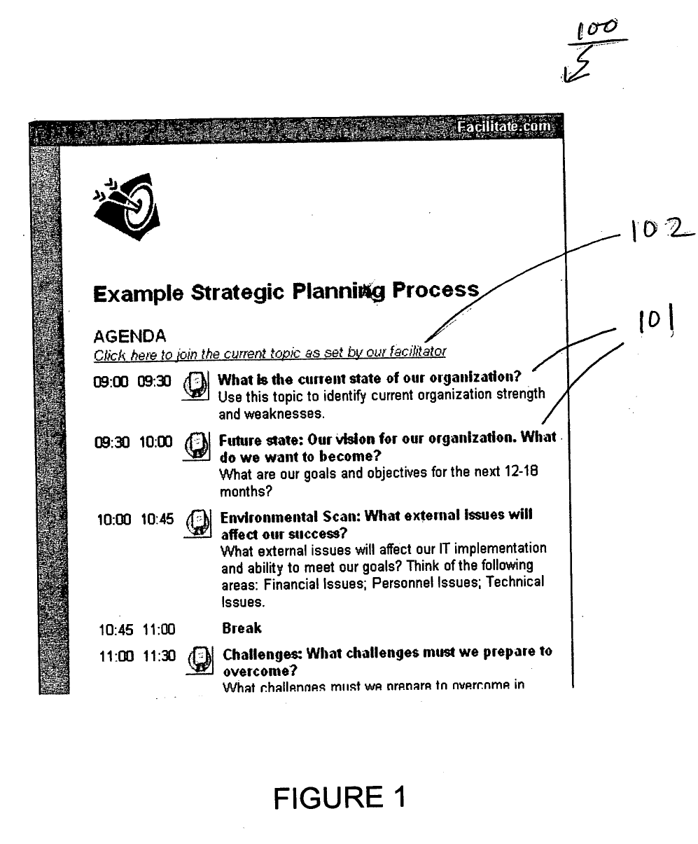

### DETAILED DESCRIPTION OF EXEMPLARY EMBODIMENTS OF THE INVENTION

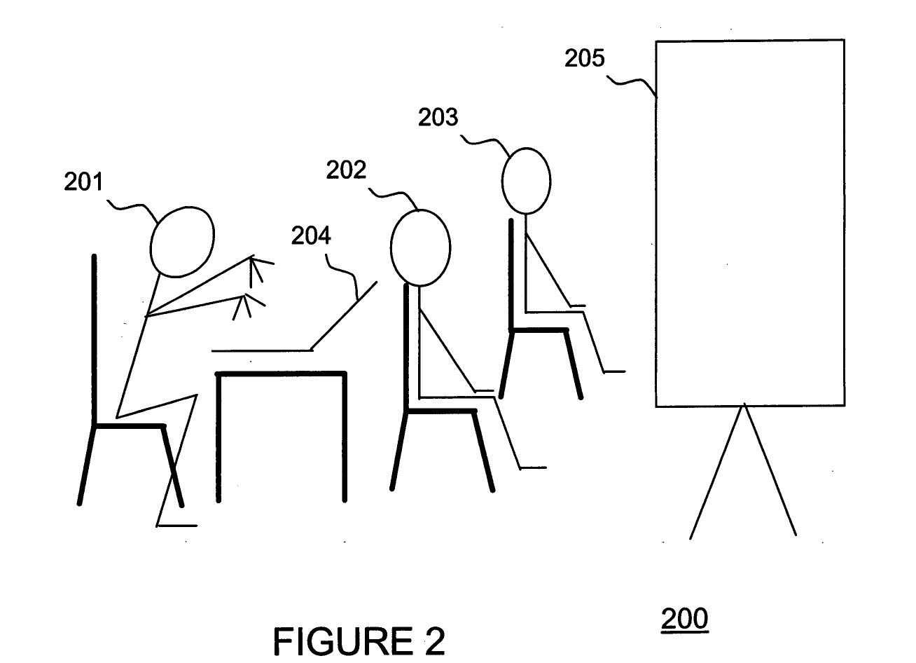

Referring now to the drawings, and more particularly to FIGS. 2-10, exemplary embodiments of the present invention will now be described.

It is noted that one of ordinary skill in the art, after having read the details described herein, would readily be able to apply the present invention as a generalized concept adaptable in almost any group intervention and in various embodiments similar to those described herein.

The present invention provides a method and system for learning interventions and group facilitation using a computer delivery system. The inventors refer to the modules of the present invention as ‘Impact Guides’. The purpose of Impact Guides is to guide groups and their leaders to adopt practices that optimize their performance through appropriate use of new behaviors. When used successfully, groups change their behavior, which results in improved performance.

For example, assume that a group is assembled for the task of generating a mission statement. The Impact Guide in accordance with the present invention would, for example, first define the task to the group (e.g., to generate a mission statement).

The Impact Guide might then teach the group something about the task, such as explaining what a mission statement is, the significance of a mission statement, why an effective mission statement is important, and some characteristics of a good mission statement.

The Impact Guide would then instruct the group to perform a task related to the generation of the mission statement and provide the means to record the task development and accomplishment.

The Impact Guide approach of the present invention is readily adapted to “embedded into work” learning. These are learning environments in which the primary focus is on completing work as part of an assigned role, in which, however, learning is necessary, in the moment, to accomplish the work effectively and efficiently.

An example of embedded into work learning might be that of a team member learning how to run an effective e-meeting by using an e-meeting tool having good meeting practice built into the tool. For example, the meeting purpose and agenda might be required fields in the invitation form. A second example might be a sales team that learns the key elements of a good account plan as they conduct their account planning session.

As will be apparent after understanding the following discussion, the Impact Guide concept of the present invention can provide a better way to learn when:

concepts are simple or familiar;

learner responses and questions are predictable;

learning is situation dependent;

learning supports performance; and/or

the participant population is large and the time to prepare is short.

The Impact Guides of the present invention provide a work-based, multi-disciplinary approach that incorporates work process methodology, instructional design, graphic design, and, in an exemplary embodiment, readily available FLASH™ technology.

It is noted that the Impact Guide concept of the present invention is more than a learning module or a training module. That is, training happens in a single direction. This means that the learner takes in the information and, possibly, subsequently undergoes a proficiency test to demonstrate that the information is understood.

In contrast, the Impact Guide modules of the present invention, include more than training related to the task, since it further guides the group through the completion of the actual task itself. It is, therefore, a form of “embedded learning” in which the participants receive the training as the task is being completed. Impact Guides might be designed to implement a single task in one module, or there could be several tasks to be accomplished in the same module. If an Impact Guide is used several times by a group, the user can skip over various steps, since its teaching aspect would have been accomplished during the first time that the module is used.

By the same token, if the group needs “refresher” training or it is important to ensure that all members are performing the group task under the same understanding or that new group members are quickly brought “on board”, the Impact Guide provides a condensed learning section related to the task.

The Impact Guides of the present invention automate group interventions and group facilitation. They embody expertise and proven best practices. They apply this expertise in an automated fashion within the context of a group's real work by facilitating dialogue and group interaction.

These Guides can be designed to anchor their purpose around a business object, such as a project or a business process. A more subtle, implicit purpose is to use best practices for improved productivity. Moreover, the Impact Guides inherently provide an environment in which the user is largely unaware of this implicit purpose, so that participants learn without expecting or intending to learn.

Thus, the Impact Guide concept described herein can appropriately be described as a framework into which can be adapted almost any kind of group intervention.

As a brief introductory summary, the Impact Guides of the present invention provide guidance to a group for the specific task to be accomplished, provide a method similar to a “whiteboard” upon which the group can use for developing and documenting the assigned task, provide a method that allows the work product of the group's efforts to be saved and/or imported into a subsequent task Impact Guide (e.g., without having to “re-key” the information developed during a session) or an application program that will use the group's effort as an input, and can even alert the group when it is time to move on to the next portion of the group task.

To explain the concept of the Impact Guide, FIG. 2 exemplarily illustrates a scenario 200 in which a first group, which exemplarily comprises a small number of managers or team leaders 201, 202, 203 as members of the first group. The first group has the group task of developing a plan for a future meeting that is intended to achieve a task involving a larger team effort. The larger team is a second group, and the larger team effort is the group task of the second group.

Therefore, in this scenario 200, group members 201, 202, 203 are led through a proven team development process for effective technology-supported collaboration, as guided by the Impact Guides of the present invention. This scenario also demonstrates a key feature of the Impact Guides in which data or work product generated during one group meeting can be stored on the users' memory device (e.g., computer hard drive, portable memory, etc.) and, from the users' point of view, “appears to be” transferred between the Guides to become the Impact Guide for the second group meeting. It could also be transferred to some other electronic application. For example, in the example of a management team working to allocate bonus funds among employees, the Impact Guide could send the group's decisions to a compensation system for processing and distribution.

In this scenario 200, the first Impact Guide (e.g., in this scenario, a so-called Planning Impact Guide) exemplarily takes the first group members 201, 202, 203 (who might become group leaders for the subsequent team effort) through a working session to plan the team project initial launch meeting, to develop a collaborative work process for the team project, and to collaboratively incorporate technology into their process (e.g., the first group's tasks are these three tasks).

The three group members receive information in Instruction screens, as displayed on a user's computer screen, typically additionally projected on an overhead projection device 205 for convenience of viewing by the entire group. The group members use this information to interact with each other, supported by the Guide's Interaction screens and exercises, to achieve the group tasks. The outcomes of their interactions are materials that are saved on the PC 204 memory (e.g., hard drive) to be later accessed by another Impact Guide (e.g., the so-called Launch Impact Guide).

The second Impact Guide, the Launch Impact Guide, provides a framework for the second team's launch meeting (e.g., the second group's initial task) and co-facilitates the session. The second Guide delivers information, facilitates group discussions, and captures key interactions. Outcomes are saved by the Guide as team resource materials. The team leaders control the Guide and perform the role of team leader.

Thus, in this exemplary scenario, two Impact Guides have separately guided two groups through their respective group tasks (e.g., first a planning group task and, second, a team to implement the first group's plan). It should be apparent that additional levels of group tasks can be similarly sequenced to use outputs of one group as inputs into another group task or as inputs into an Impact Guide.

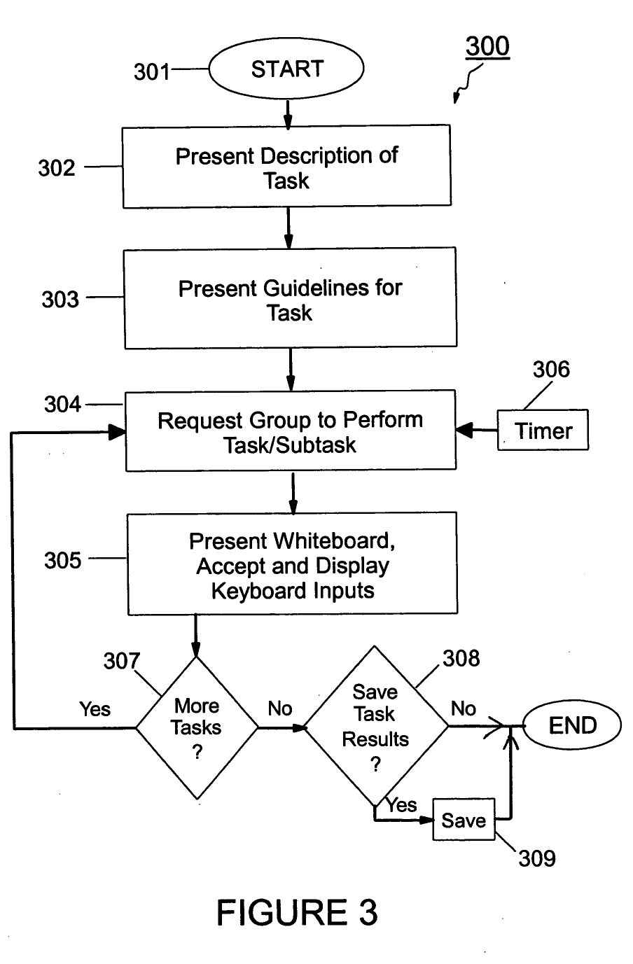

FIG. 3 shows a typical Impact Guide scenario in flowchart format 300, along with FIG. 2. For the session, there might be exemplarily eight or ten people assembled in a conference room for a group working session.

One group member 201, typically the person who will serve as the meeting moderator/facilitator, would bring a laptop 204 upon which is stored the Impact Guide designed for the specific task to be performed in that session and connects the laptop to an overhead projector 205. This person might typically also operate, during the session, the keyboard and controls of the computer to move through the pre-programmed steps of the Impact Guide.

In step 301 of FIG. 3, the operator starts the Impact Guide module to begin the session.

As shown in step 302, a typical Impact Guide would first provide an introductory description of the task to be achieved, perhaps including comments about the significance of the task and a description of characteristics of an optimal task result. This introductory description would typically include one or more visual presentations on the overhead 205, similar to a PowerPoint™ presentation, along with an accompanying audio. The computer operator (e.g., facilitator) might use a mouse pointer or other input device to move through the “slides” of the presentation, again, similar to the technique of a PowerPoint™ presentation.

In step 303, the Impact Guide then moves forward into a pre-programmed set of “guidelines” for the specific task at hand, again, exemplarily using audio and visual presentations and with the facilitator moving (e.g., clicking a prompt with a mouse) through the presentation slides.

As shown in step 304, eventually, the Impact Guide instructs the group to perform a task or subtask, and, if appropriate, in step 305 presents a “whiteboard” area (e.g., via the overhead 205) to be used as a workspace. In achieving the task, the group develops one or more results, and the facilitator documents the development. The work is presented as it happens on the overhead by typing via a keyboard or the like.

A timer module 306 might provide a time limitation for a task/subtask, such that the group is given a pre-set amount of time to perform that step. This timer feature allows the Impact Guide to move the group forward so that the expected task is completed within a predetermined time interval. This timing feature is similar to conventional facilitated meetings in which a meeting facilitator is expected to conduct the work session to end, for example, in one hour and uses a watch to monitor when each stage's time has expired.

To move forward to the next task/subtask, in step 307, the operator clicks on a “NEXT” command.

In step 308, the work product of the session (e.g., the contents of the various whiteboards) can be stored for future use or, possibly, automatically moved forward into an application that requires the results of the task. For example, in a meeting in which managers have the group task of ranking employees, the ranked listing might be automatically forwarded into an application related to the payroll function by saving the session work product.

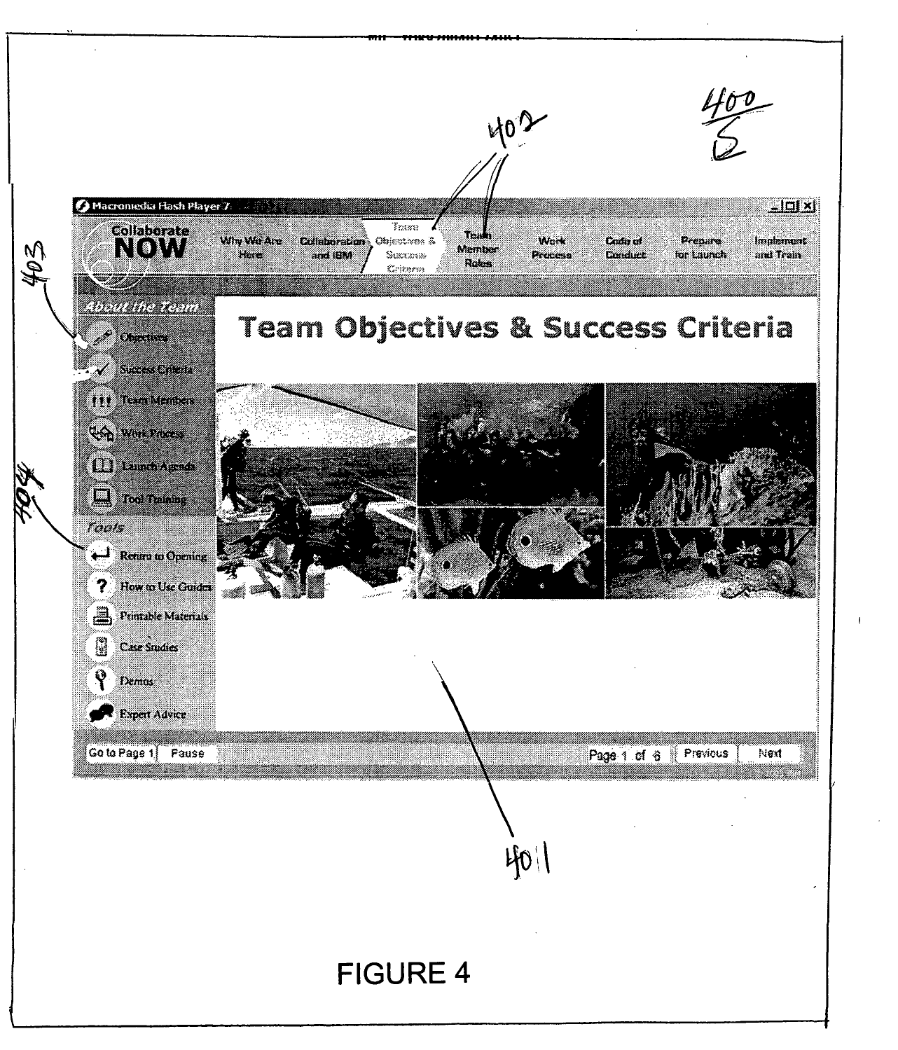

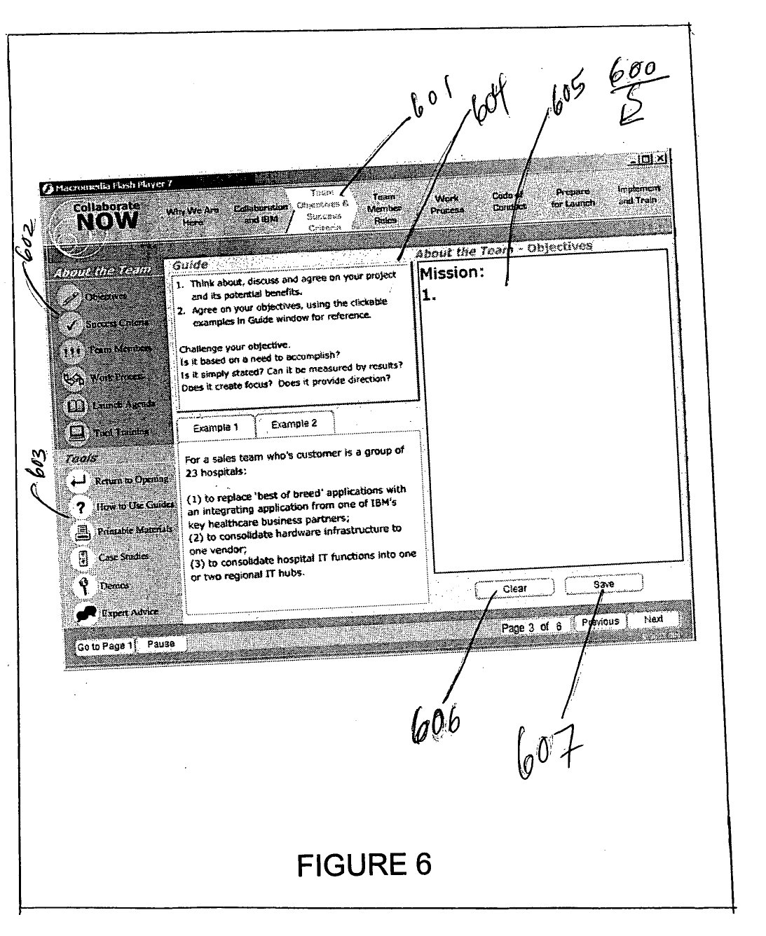

FIGS. 4 and 6 show examples of how the Impact Guides are designed to provide the above-described group task guidance and interaction. There are exemplarily two types of screens in an Impact Guide: Instruction Screens (e.g., 400 in FIG. 4) and Interaction Screens (e.g., 600 in FIG. 6).

An exemplary Instruction Screen 400 in FIG. 4 has a presentation window 401 to be the main stage for visual content for the meeting, dedicated to the instructions or other learning information. This information or instructions would appear similar to conventional PowerPoint™ presentations. These screens are designed to set up content and teach a group task. The user would move forward through the screens using, for example, a mouse click or keyboard spacebar or other input device.

The Section Navigator 402 displays the main topics in the module, exemplarily across the top of the screen. Each topic is highlighted when pages within it are active. The Section Navigator 402 allows the user to navigate between sections of the Impact Guide module, measure progress through the unit, and serves as an orientation device. The Section Navigator 402 is persistent on all screens.

The Deliverables Navigator (“About the Team”) 403 is displayed on the left side of the page and links to data saved by the user. As data is saved, a checkbox (not shown) is displayed as superimposed on the respective icon in the navigator 403 to record progress through the system. This navigator 403 allows users to navigate rapidly to activities and deliverables, and check progress against completion.

The Tools Navigator 404 is displayed below the Deliverables Navigator on the left side of the screen, with links to Internet or Intranet pages, or to additional Flash™ modules for additional instructional support.

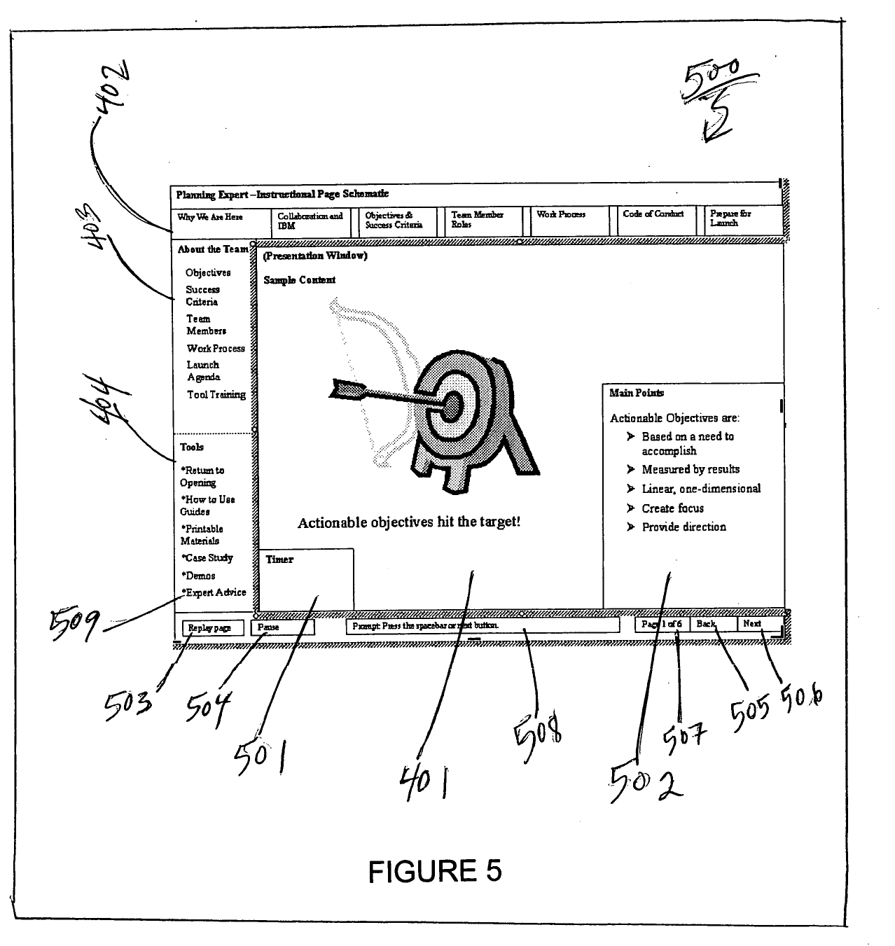

FIG. 5 shows an exemplary schematic 500 of the Instruction Screen page 400 previously shown in FIG. 4, including the previously-discussed presentation window 401, section navigator 402, deliverables navigator 403, and tools navigator 404. This schematic 500 also shows a timer display 501 and main points display 502. The timer 501 can appear automatically whenever an activity begins. The user can interactively add additional minutes, if desired. The main points display 502 appears as a pop-up window at the end of narration summarizing the learning content.

Most of the remaining features of the schematic 500 are self-explanatory The “Replay Page” icon 503 allows the page to be replayed and the “Pause” icon 504 allows the movie being presented in the presentation window 401 to be paused/unpaused. The “Back” and “Next” icons 505, 506 allow the user to click between pages, and the page identification icon 507 identifies the current page being viewed in the presentation window 401. Instruction icon 508 provides instructions to the user.

The “Expert Advise” icon 509 is designed to be addressing the facilitator as its target audience. This series of instructions will provide answers to questions that ajunior facilitator might ask a senior facilitator as to the tips and traps that the senior facilitator might provide the junior facilitator going into the group intervention for the first time.

FIG. 6 exemplarily shows an Interaction Screen 600 upon which the group will use as an interaction tool. Again, the persistent Section Navigator 601 is exemplarily at the top and the Deliverables Navigator 602 and Tools Navigator 603 on the left.

The Guide pane 604 presents directions for the task and instructional support content, plus examples at the bottom. The user “write field” 605 accepts and displays text input and “Clear” and “Save” icons 606, 607 control the write field information. The group would use the write field 605 as a visible working surface upon which to develop or record ideas or work product of the group's efforts, similar to the way a “whiteboard” is often used in group settings.

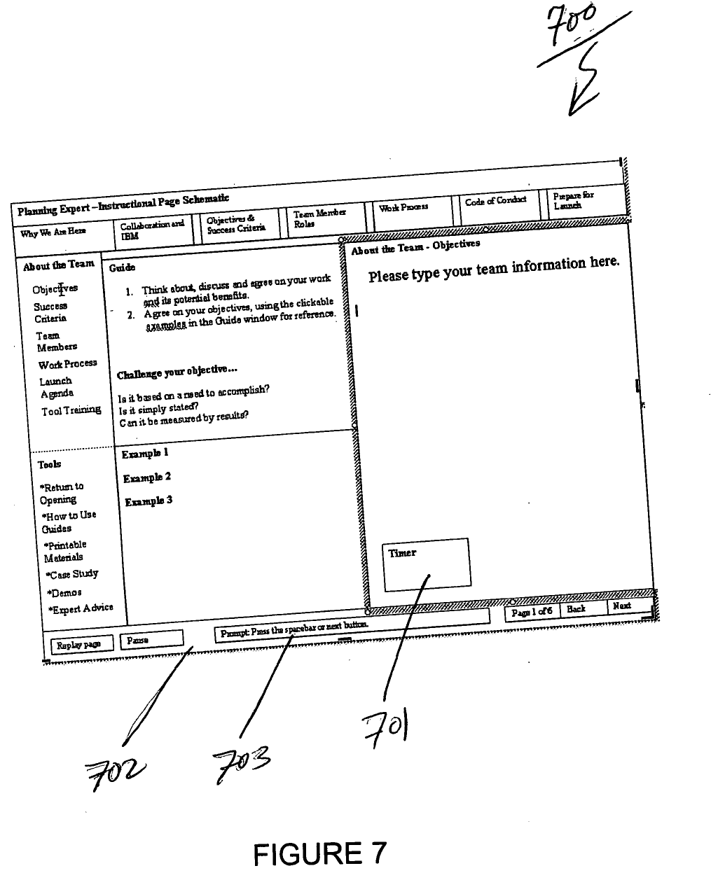

The Interaction Screen schematic 700 in FIG. 7 exemplarily shows schematically the layout of the interaction screen 600. Similar to the schematic 500 of the instructional page, the schematic 700 additionally shows the timer 701 that can appear automatically whenever an activity begins. The navigator 702 at the screen bottom allows the user to check current position, navigate to the next page, replay a page, or pause. The center prompt 703 cues the user for the next action.

In the above scenario, the first two Impact Guides are designed to launch a project team: a Planning Impact Guide and a Launch Impact Guide. This is how they work.

The Planning Guide automates the process of preparing for a launch meeting. A leader interacts with the Guide to produce all of the materials needed to work with their team. Now prepared, the leader holds a team meeting using the second Guide (e.g., the Launch Guide). This Guide fulfills the roles of facilitator, presenter and subject matter expert. Transferring stored data from the Planning Guide, specific job-related content is integrated into the session. The Launch Guide facilitates the actual meeting, and orchestrates the leader/group interaction.

The Guides are self-paced and user-directed. Once the executable has been downloaded to a PC hard drive, a group leader may re-use the Guides to launch as many teams as he likes.

From the above description, it can be seen that Impact Guides provide a unique form of e-Learning that integrate knowledge acquisition, performance support, and e-learning. They are directed at improving human performance in an organization. They increase productivity, reduce re-work, increase quality, and may reduce cost.

Impact Guides eliminate the need and cost for a certified expert (e.g., human) in the target tasks and the need for a meeting facilitator. Guides integrate performance support that both reinforces learning and eliminates the need for a specialized meeting facilitator. They use current work as the training activity. Tasks are completed immediately applying new knowledge which eliminates the problem of learning transfer. Then, the Guide facilitates the group's interaction as they apply what they have to their work. There is no need for a facilitator. The interactive delivery medium is a computing device (processor) whose display screen preferably can be projected for the entire group.

The actor James Garner, when asked if he had a theory about acting, responded, “I do. Never let anybody catch you at it.” Similarly, while using no more time than would typically be required for a task (work object, planning session, etc.), the Impact Guides of the present invention allow a learner to increase the odds of success, improve productivity, and build skill. Guides deliver these improvements without requiring training or time consuming pre-work.

Impact Guides may be created for any number of topics that are appropriate for work-embedded learning. In other words, they deal with concepts that are simple or familiar, learner responses and questions are predictable, learning is situation dependent, learning supports performance, the learner population is large, and the time to prepare is short.

Groups and leaders want to get their job done as quickly and easily as possible. They want to achieve their objectives and engage group members. Users expect the Impact Guide to give them performance support for simple or familiar tasks. In addition, the Guide embeds learning of best practices into the group's work.

After using the Guide several times, leaders and groups have learned best practices and begun to develop the habits of new behavior. The first instances of the Impact Guides take leaders and teams through a proven process for effective technology supported collaboration. In training terms, this is a learning intervention on effective teamwork. The specific learning goal is to inform and to provide performance support for a set of tasks. This is considered “work-embedded” learning.

In a preferred embodiment, the Impact Guide method and system are implemented using Flash™ technology and are designed to be downloaded and used on a local PC or laptop. Flash modules run as user-controlled audio-visual support that save and provide access to saved data. However, one of ordinary skill in the art will readily recognize, after taking this disclosure as a whole, that this exemplary embodiment can be easily expanded so that the Impact Guides are embedded onto other platforms and scenarios.

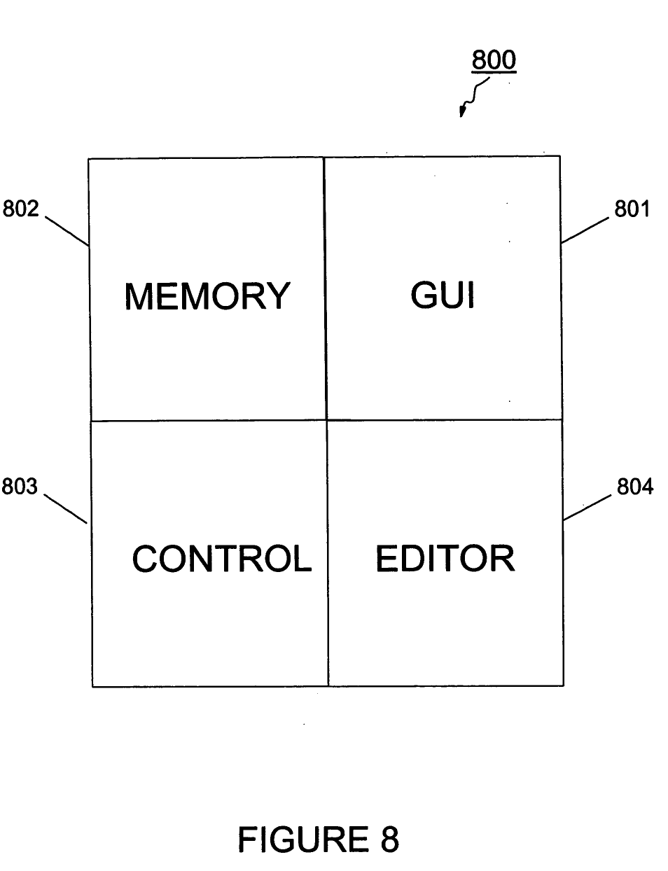

FIG. 8 illustrates an exemplary block diagram 800 of the component modules comprising the present invention.

Graphical User Interface 801 permits user interactions, including the movement within the sections and pages of an Impact Guide module and the entry of group inputs into the whiteboard.

Memory block 802 stores the information to be presented as learning information, instructions, guidelines, etc., the format and layout ofthe presentations, and, if applicable, the group's work product from the whiteboard. As noted previously, the memory can also be used to store information developed in one Impact Guide session to become the basis for a subsequent Impact Guide, or to be forwarded to an external application that uses the information developed during a meeting task.

Control module 803 performs the administrative tasks such as changing the display in accordance with the above descriptions, moving display information into and out of memory 802, and creating and controlling the timer function.

Editor module 804 can be added for allowing a module developer to enter the contents to be displayed as learning information, guidelines, etc., for new Impact Guide modules. That is, although the present invention can be adapted to be mounted onto existing platforms, such as Flash™ technology upon which the prototypes have been incorporated and that do not incorporate an editor for creating new Impact Guide modules, it is not so constrained. One of ordinary skill in the art would readily recognize, after taking this discussion as a whole, that the present invention could be embedded in an integrated tool for Impact Guide module development that includes an editing module for placing information into Impact Guide templates.

To summarize the benefits provided by the present invention, the six problems with group interventions can be revisited in view of the Impact Guides.

Response to Problem #1. To maximize productivity, interactions need to be structured based on best practices and some way to learn how to adapt them to a group's own use. Impact Guides are the first work-embedded e-leaming tool that teaches best practices through interactions that use a group's own work as the context of the learning. Interactions between the Guide and the users are structured to teach and to create a concrete output which is immediately usable by the group in their work. The experience is of “doing”, rather than “learning.”

For example, the first Guide (cited above) takes a group step-by-step through creating a Code of Conduct after first teaching what it is and the best practices for developing and using one. Typically, work-embedded learning or “on the job training” has been procedural, such as learning to use a machine, rather than conceptual, such as understanding and then putting the principles of group dynamics into practice. Moreover, work-embedded learning is typically not customizable to a group's unique needs.

Response to Problem #2. Groups need access to best practices and a way to learn how to use them that fits within their busy calendars. eLearning is a practical alternative for busy individuals who can schedule training to meet their specific schedule, but coordinating training for a group, either traditional or electronic is extremely difficult. As a result, teams generally work inefficiently, and below their potential.

Impact Guides embed group interaction best practices without using dedicated training time or pre-work to learn them. In fact, learners may be unaware of the learning that is embedded in the work. When finished, the group has learned and used a proven method.

Response to Problem #3. A group will not be effective until all members are trained. All members must use the same tools and agree how they will be used. Impact Guides deliver work-embedded learning for a complete team, so that there is no waiting for individual team member training. The entire group has learned together and therefore all can apply their new knowledge without delay.

Response to Problem #4. Many performance support tools bypass learning by providing a pre-prepared decision or work artifact, such as the spellcheck function in MS Word which corrects spelling errors on the fly. Impact Guides do not offer a menu of pre-prepared content. They teach principles based on best practices prompting learners to create unique, group-specific solutions. This hands-on approach supports learning and experimentation.

Response to Problem #5. Transferring newly learned knowledge to the job is an ongoing problem for training programs. If new knowledge is not used, then it is not retained.

Impact Guides are truly work-based action learning. The first application of learners' new knowledge happens as the learning occurs. Learned principles can be re-applied and adapted over time as the environment or situation changes and skills and experience deepen. Integrating learning and doing removes the learning transfer step from the process of learning.

Response to Problem #6. In the name of cost-savings and urgency, employees are asked to be experts in many fields in addition to their specific subject matter expertise. Few employees are skilled in myriad fields, nor do they have the time to build skills at the expense of doing their assigned tasks.

Employees must choose to build their own skills, hire the expertise they do not have, or do without. Impact Guides reduce the cost of external experts without sacrificing the level of expertise while accommodating a high level of urgency. Guides assist learners in implementing best practices by augmenting learner skills through information and interactions.

In organizations that routinely employ professional facilitators and focus group leaders, this may even eliminate work categories, freeing professionals to deliver value in another way.

Another key aspect of the present invention is its potential to be the basis of various types of services or business. In this aspect, the present invention might serve as the basis for a service that actually conducts meetings in accordance with the concept of the Impact Guides described herein or provide and maintain the facilities therefor. Another possible service would be the development of new Impact Guide modules or a consultant for such module development.

Along these lines, the present invention is easily adapted for conducting e-meetings at multiple locations interconnected via a computer network such as an intranet or the Internet. In this scenario, each location would have a display of the active screen and each location would have capability to enter into the whiteboard. Therefore, another service possible with the present invention would be the facilitation of e-meetings using the Impact Guides, the service of conducting such an e-meeting, or the service of providing the infrastructure for such e-meetings.

Exemplary Hardware Implementation

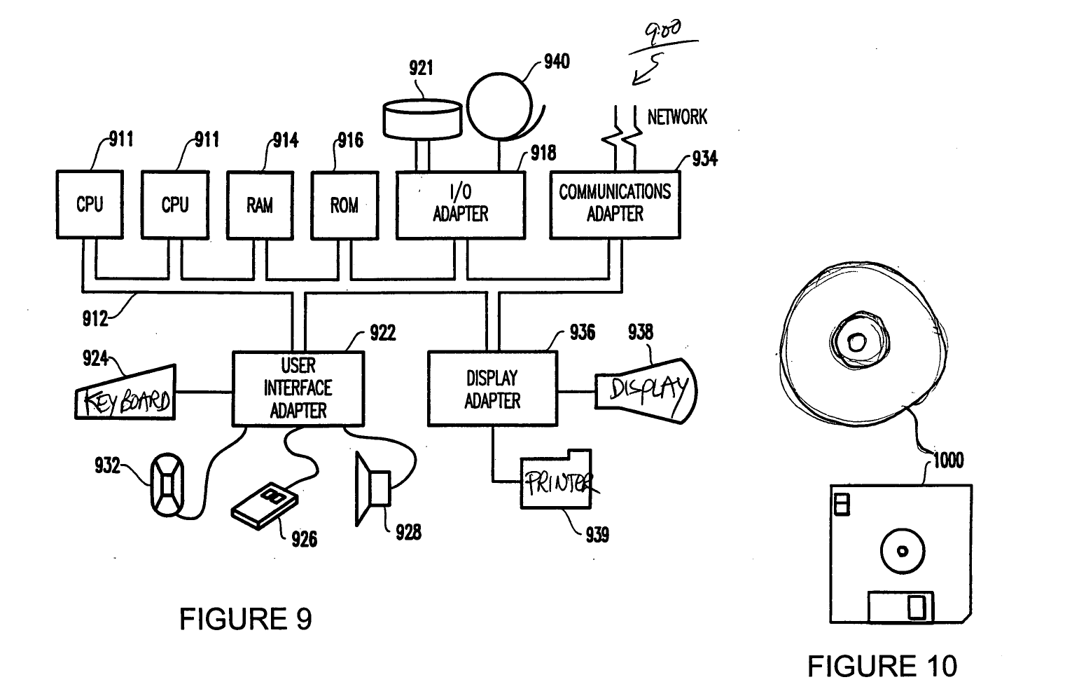

FIG. 9 illustrates a typical hardware configuration of an information handling/computer system in accordance with the invention and which preferably has at least one processor or central processing unit (CPU) 911.

The CPUs 911 are interconnected via a system bus 912 to a random access memory (RAAM) 914, read-only memory (ROM) 916, input/output (IO) adapter 918 (for connecting peripheral devices such as disk units 921 and tape drives 940 to the bus 912), user interface adapter 922 (for connecting a keyboard 924, mouse 926, speaker 928, microphone 932, and/or other user interface device to the bus 912), a communication adapter 934 for connecting an information handling system to a data processing network, the Internet, an Intranet, a personal area network (PAN), etc., and a display adapter 936 for connecting the bus 912 to a display device 938 and/or printer 939 (e.g., a digital printer or the like).

In addition to the hardware/software environment described above, a different aspect of the invention includes a computer-implemented method for performing the above method. As an example, this method may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 911 and hardware above, to perform the method of the invention.

This signal-bearing media may include, for example, a RAM contained within the CPU 911, as represented by the fast-access storage for example. Alternatively, the instructions may be contained in another signal-bearing media, such as a magnetic data storage or CD diskette 1000 (FIG. 10), directly or indirectly accessible by the CPU 911.

Whether contained in the diskette 1000, the computer/CPU 911, or elsewhere, the instructions may be stored on a variety of machine-readable data storage media, such as DASD storage (e.g., a conventional “hard drive” or a RAID array), electronic read-only memory (e.g., ROM, EPROM, or EEPROM), an optical storage device (e.g. CD-ROM,, DVD, etc.), or other suitable signal-bearing media including transmission media such as digital and analog and communication links and wireless. In an illustrative embodiment of the invention, the machine-readable instructions may comprise software object code.

As has been discussed above, the present invention provides a number of benefits, including the capability of “just-in-time” learning. It also provides a work-based learning approach for groups that maximizes value from the time spent as a group. Its flexible design supports customized learning paths for all levels of experience and knowledge.

Moreover, the electronic facilitation produces scaleable and repeatable learning, and reduces duplication of effort, and it has a low “delivery” cost. It provides a technology-enabled way to facilitate that can avoid the cost of travel, facilities, etc.

It provides the ability to be able to use recommended practices quickly, without traveling or attending a class. It provides the ability to learn-by-doing, thereby embedding action-learning into work. It avoids the problem of knowledge transfer. The present invention can be used without prework, meaning that there is no training to accomplish a group task. It provides a method to learn-while-doing, with lower risk of failure.

Non-limiting additional applications and/or environments which would benefit from the present invention might include:

any consulting methodology that uses a simple or familiar concept;

a process-based decision making;

a structured group decision (or activity);

business and project planning;

situations where sensitive material or words need to be communicated in a way that ensures a consistent message is conveyed and that work is completed consistently;

a problem solving technique similar to that developed by General Electric for internal use, sometimes referred to as a “GE Work-Out” type problem solving. It has since become famous in the business world and is widely used in many companies. This is a technique in which a diverse group of people who are affected by a certain problem come together over a short period of time to recommend solutions to the problem. They follow a problem solving process that enables them to fully understand the problem, brainstorm possible solutions, make recommendations and propose action plans; and

sales calls where the client needs to customize the offering, especially services products.

While the invention has been described in terms of exemplary embodiments, those skilled in the art will recognize that the invention can be practiced with modification within the spirit and scope of the appended claims.

Further, it is noted that Applicants' intent is to encompass equivalents of all claim elements, even if amended later during prosecution.

Having thus described our invention, what we claim as new and desire to secure by Letters Patent is as follows:

1. A computerized method of conducting a group intervention, said method comprising:
executing a group intervention module that includes a set of instructions to guide said group through a completion of a group task as said group task is. being executed by said group.

2. The method of claim 1, wherein said module further includes information for training members of said group concerning said group task.

3. The method of claim 1, wherein said module further includes:
an input port for receiving inputs from said group as said group task is being executed; and
a display window to display said inputs to be visible to said group.

4. The method of claim 1, wherein said module further includes a timer function to advise said group of a time limit for performing said group task.

5. The method of claim 3, wherein said module further includes an output port to allow said inputs from said group to be saved in a memory.

6. The method of claim 3, wherein a work product of a group intervention work session conducted in accordance with said module can be supplied to another application.

7. The method of claim 6, wherein said group intervention module comprises a first group intervention module and said another application comprises a second group intervention module and said group task as instructed by said first group intervention module comprises a preparation of said second group intervention module.

8. A computerized method of embedded learning, said method comprising:
executing a group intervention module that includes a set of instructions to guide a group through a completion of a group task as said group task is being executed by said group.

9. The computerized method of claim 8, said method further comprising:
receiving inputs from said group as said group task is being executed.

10. The computerized method of claim 9, further comprising:
displaying said inputs so as to be visible to said group as said group task is being executed.

11. The computerized method of claim 9, further comprising:
selectively saving said inputs into a memory.

12. The computerized method of claim 9, further comprising:
selectively exporting said inputs into another application.

13. An e-learning module, comprising:
a set of instructions to guide a group through a completion of a group task as said group task is being executed by said group.

14. An e-leaming module of claim 13, further comprising:
at least one presentation providing information for training members of said group concerning said group task.

15. An e-learning module of claim 13, further comprising:
a timer to advise said group of a time limit for performing said group task.

16. An e-leaming module of claim 13, further comprising:
an input port for receiving inputs from said group as said group task is being executed; and
a display window to display said inputs to be visible to said group.

17. An e-leaming module of claim 16, further comprising:
an output port to allow said inputs from said group to be at least one of:
saved in a memory;
transported to an external application program; and
transported into another e-leaming module.

18. An apparatus, comprising:
a memory storing an e-learning module including a set of instructions to guide a group through a completion of a group task as said group task is being executed by said group.

19. The apparatus of claim 18, wherein said e-learning module includes a working display to display inputs received as said group task is being executed, said apparatus further comprising:
an input device for receiving inputs from said group as said task is being executed; and
a connection to a display window to display said inputs to be visible to said group.

20. A system, comprising:
a processor;
a memory storing an e-learning module for being executed by said processor, said module including a set of instructions to guide a group through a completion of a group task as said group task is being executed by said group.

21. The system of claim 20, wherein said processor comprises a first processor, said system further comprising:
a second processor interconnected to said first processor, said second processor concurrently processing said e-learning module in parallel with said first processor such that both said first processor and said second processor provide a common display of said execution of said e-leaming module and at least one input into said second processor is used as information input into said processing of said e-leaming module.

22. A computerized tool to prepare an e-learning module, said tool comprising:
a graphical user interface to allow entry of an input from an input device and to provide a display on a display device;
a memory containing at least one template for information to be presented in said e-learning module; and
an editor to receive said input and place said input into a format for a module template,
wherein at least one said module template provides a set of instructions to guide a group through a completion of a group task as said group task is being executed by said group.

23. A signal-bearing medium tangibly embodying a program of machine-readable instructions executable by a digital processing apparatus to perform a method of conducting a group intervention, said method comprising:
presenting a set of instructions to guide said group through a completion of a group task as said group task is being executed by said group.

24. A signal-bearing medium tangibly embodying a program of machine-readable instructions executable by a digital processing apparatus to execute a computerized tool to prepare an e-learning module, said tool comprising:
a graphical user interface to allow entry of an input from an input device and to provide a display on a display device;
a memory containing at least one template for information to be presented in said e-learning module; and
an editor to receive said input and place said input into a format for said template,
wherein at least one said template provides a set of instructions to guide a group through a completion of a group task as said group task is being executed by said group.

25. A method of developing an e-leaming module for a group intervention, said method comprising:
using a graphical user interface on a user terminal to enter information into a format for an e-leaming module template,
wherein said template provides a set of instructions to guide a group through a completion of a group task as said group task is being executed by said group and said information being entered comprises said set of instructions.

26. A method of implementing embedded learning, said method comprising at least one of:
presenting an e-leaming module to a group, said e-learning module including a set of instructions to guide a group through a completion of a group task as said group task is being executed by said group;
participating as a group member in said group in which said presenting occurs;
providing a facility for said presenting;
providing a service for said presenting;
preparing said e-learning module; and
providing a service for advising said preparing.
